(19) United States
(12) Patent Application Publication
(10) Pub. No.: US 2011/0108421 A1
(43) Pub. Date: May 12, 2011

(54) ELECTROCHEMICAL METHODS AND PROCESSES FOR CARBON DIOXIDE RECOVERY FROM ALKALINE SOLVENTS FOR CARBON DIOXIDE CAPTURE FROM AIR

(76) Inventors: Klaus S. Lackner, Dobbs Ferry, NY (US); Allen Wright, Tucson, AZ (US)

(21) Appl. No.: 12/941,723

(22) Filed: Nov. 8, 2010

Related U.S. Application Data
(62) Division of application No. 11/227,660, filed on Sep. 15, 2005.
(60) Provisional application No. 60/700,977, filed on Jul. 20, 2005.

(51) Int. Cl. B01D 61/44

(52) U.S. Cl. 204/537

(57) ABSTRACT

The present invention relates to methods for recovering a hydroxide based sorbent from carbonate or another salt by electrochemical means involving separation schemes that use bipolar membranes and at least one type of cationic or anionic membrane. The methods can be used in an air contactor that removes carbon dioxide from the air by binding the carbon dioxide into a solvent or sorbent.

This application is a divisional of application Ser. No. 11/227,660, filed Sep. 15, 2005, which application in turn claims priority to U.S. Ser. No. 60/700,977, which was filed on Jul. 20, 2005, which is hereby incorporated by reference in its entirety.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described herein.

### BACKGROUND OF THE INVENTION

The present invention relates to the capture of carbon dioxide from air. Processes that collect CO₂ from the air typically will rely on solvents that either physically or chemically bind CO₂ from the air. A class of practical CO₂ solvents include strongly alkaline hydroxide solutions like, for example, sodium and potassium hydroxide. Hydroxide solutions in excess of 0.1 molarity can readily remove CO₂ from air. Higher hydroxide concentrations are desirable and an efficient air contactor will use hydroxide solutions in excess of 1 molar. Sodium hydroxide is a particular convenient choice, but other solvents may also be of interest. Specifically, similar processes may be useful for organic amines as well.

The design of air contactor systems that aim to contact the air for CO₂ is dealt with in other patents and in the literature. The present invention relates to the recovery of the sorbent, wherein the CO₂ laden sorbent is rejuvenated and the CO₂ is separated from the liquid. We are describing a set of electrochemical processes that can be combined with an air capture unit to refresh the hydroxide solution and collect the CO₂ in a separate and in some cases pressurized stream.

All processes have in common that they separate sodium hydroxide from the carbonate or another salt by electrochemical means involving separation schemes that use bipolar membranes and at least one type of cationic or anionic membranes. In addition some of these processes involve conventional calcination and/or acid base reactions that lead to the evolution of gaseous CO₂. Several such processes are claimed in this invention and have been grouped into seven distinct classes.

### SUMMARY OF THE INVENTION

The overall process of CO₂ capture from air requires an air contactor that removes CO₂ from the air by binding the CO₂ into a solvent or sorbent. The spent sorbent is then processed to recover all or part of the CO₂, preferably in a concentrated, pressurized stream. The rejuvenated solvent is recycled to the CO₂ collector.

This invention lays out several processes for recovering an hydroxide based sorbent by means of electrochemical processes that can separate acids from base. Such processes exist and have been demonstrated for a variety of acids. Here we take these processes and combine them in such a way as to build a functional and efficient CO₂ recovery unit.

The advantages of this invention are several: First, the process greatly streamlines the overall flow sheet of carbon dioxide capture from air, by avoiding the intermediate step of transferring the carbonate ion to calcium carbonate which is then calcined to free the CO₂. The mass handling of such a process is complicated. The more direct electrochemical process provides also a way of reducing the overall energy consumption. Thirdly, it greatly reduces the need for complex moving equipment to manage solid material streams, as would be necessary in a conventional calcium carbonate driven recovery unit.

Finally, implementations of this type could also be used in systems that need to separate carbonate and hydroxide solutions that result from processes other than air extraction.

### DETAILED DESCRIPTION OF THE INVENTION

The patent and scientific literature referred to herein establishes knowledge that is available to those with skill in the art. The issued patents, applications, and other publications that are cited herein are hereby incorporated by reference to the same extent as if each was specifically and individually indicated to be incorporated by reference. In the case of inconsistencies, the present disclosure will prevail.

### The Building Blocks of the CO₂ Recovery System

The following building blocks are the electrochemical processes that are utilized in the CO₂ capture systems described in this invention:

1. The separation of a salt into its acid and base, where the acid and the base stay in solution by means of electrodialysis with bipolar membranes. Examples include the formation of sodium hydroxide and hydrochloric acid from sodium chloride, the formation of sodium hydroxide and acetic acid from sodium acetate. Other combinations of acid and base have also been demonstrated in the literature, in the patent literature and in industrial practice. In the context of this invention, units of this type will be used to separate a hydroxide and carbonate Solution, as well as units that separate the salt of a weak acid into the corresponding acid and base.

2. The separation of a mixture of sodium hydroxide and sodium carbonate electrochemically into sodium hydroxide and sodium carbonate. Here we can rely on existing building blocks or use specifically designed units. Clearly these approaches can be extended to other cations than sodium. These may include potassium, ammonia, or the cations of organic amines, like MEA, DEA and others. The basic reaction in all cases is that R—OH, R2C03 is separated through a membrane process into R—OH and RHCO₃.

3. The electrochemical separation of a metal bicarbonate into the metal carbonate and CO₂. This process could use electrodialysis involving bipolar membranes, but other electrolytic processes have been described in the literature.

4. The separation of the metal bicarbonate into the metal hydroxide and CO₂. Again, this process could rely on electrodialysis with bipolar membranes, but it also could be accomplished by electrolysis of metal bicarbonate producing hydrogen that is reused in a hydrogen electrode producing CO₂.

5. Units that combine steps 2 and 3 or 4 into a single unit. I.e., processes that take a mixture of carbonate and hydroxide all the way to a hydroxide solution and CO₂ gas.

The following are additional building blocks that do not involve electrochemistry:

1. A membrane process that uses concentration gradients to separate cations like sodium from the solvent to reduce or eliminate the hydroxide in the input solvent. In some cases this unit could partially transform the solvent from carbonate into bicarbonates.

2. Temperature swing processes to separate sodium carbonate from a mixture of sodium carbonate and sodium hydroxide.

3. Processes that take bicarbonate solutions to carbonate solutions by thermal or pressure swing. Such processes are conventionally deployed in certain CO₂-scrubbing systems that operate at CO₂ pressures sufficiently high for the reaction between sodium or potassium carbonate and CO₂ to form bicarbonates.

4. Processes that take bicarbonate solutions and use evaporation or thermal swings to precipitate bicarbonate from solution.

5. Processes for the calcination of bicarbonate to carbonate. Specifically of interest here are sodium or potassium carbonates and bicarbonates.

6. A process that mixes an acid with hydroxide-carbonate mixture to neutralize the mixture and to form solid precipitates of these salts. The process can stop either at pure carbonate or move on to form carbonate/bicarbonate mixtures or move all the way to bicarbonate.

7. A process that uses an acid to drive all CO₂ out of the bicarbonate, or carbonate or hydroxide mixture. This process can be performed at elevated pressure in order to deliver the CO₂ at pipeline pressure.

The following examples illustrate the present invention, and are set forth to aid in the understanding of the invention, and should not be construed to limit in any way the scope of the invention as defined in the claims which follow thereafter.

### EXAMPLES

### Example 1

### A Sketch of the Overall Process Schemes

All processes begin with the extraction of carbon dioxide from air in a unit that here is not further specified. The details of this unit are not of interest here, except that we expect this unit to consume a hydroxide based solvent that is fully or partially converted into a carbonate. The input solvent may contain other chemicals than just the hydroxide. For example it could contain certain additives that improve the process performance, but it in particular it could contain residual carbonate from previous process cycles.

The purpose of this invention is to outline processes and methods for recycling the solvent and a partial or complete recovery of the CO₂ into a concentrated stream preferably at a pressure suitable for the following processing steps. In the following discussion for the sake of clarity we will refer to specific hydroxides and specific acids. However, we emphasize that the process is not limited to these specific examples.

In the following example the air contactor unit uses a sodium hydroxide solution whose concentration is in excess of a mole per liter of sodium hydroxide. Some remnant carbonate may still be in the solvent but as the solvent is exposed to air, hydroxide is converted into carbonate and the carbonate concentration of the solution starts rising until further conversion would not be desirable. There are several reasons for stopping the absorption process. In particular the process may be stopped because the hydroxide is exhausted, or the carbonate concentration reaches saturation levels. For most capture designs precipitation of carbonate in the absorber would be undesirable. The resulting carbonate solution is then returned from the capture unit for further processing.

Conceptually, one can consider three steps in the recovery process:

1. Separation of unconverted hydroxide from the carbonate

2. Acid/base decomposition of sodium carbonate into sodium hydroxide and sodium bicarbonate

3. Acid/base decomposition of sodium bicarbonate into sodium hydroxide or sodium carbonate and carbonic acid.

In some implementations these steps could be combined together into two process steps or even a single process step.

Alternatively, one can accomplish each of these steps by neutralizing the base, (here sodium) with a weak acid. If the acid precipitates, then the process can be stopped at any point, otherwise it has to run to completion in which case the result is gaseous CO₂ and the salt of the base. If the air capture uses sodium hydroxide and the acid is acetic acid, the result would be sodium acetate, The resulting sodium acetate would be separated into sodium hydroxide and acetic acid. Both of them are recycled. The decomposition of sodium acetate is best accomplished with electrodialysis units encompassing bipolar membranes.

### Process 1:

Process 1 breaks the upgrading of the solvent into three distinct steps. First it separates a large fraction of the carbonate from the brine, then it uses an electrochemical step to in effect withdraw sodium ions from the brine leading to sodium hydroxide and sodium bi-carbonate. Finally the resulting sodium bicarbonate releases its CO₂ under addition of an acid, which again is recycled in a electrochemical step. The advantage of this process implementation is that it combines high energy efficiency, with the ability to produce pressurized CO₂.

### Step 1.1

Extract sodium carbonate from the spent solvent by a temperature swing. Sodium carbonate solubility is far smaller than that of sodium hydroxide. (Similar reasoning applies to some of the other hydroxides, but this implementation is limited to those for which the solubility ranges match), Consequently, for concentrated hydroxide solutions the maximum amount of sodium hydroxide that can be converted to sodium carbonate by CO₂ absorption is limited. One disadvantage of operating at high sodium hydroxide concentrations is that the spent solvent is still dominated by sodium hydroxide, which should not be processed through a number of expensive stages. The temperature swing method overcomes this problem because it allows one to separate the carbonate without having to pass all sodium hydroxide through membrane systems. If the spent solution is nearly saturated in sodium carbonate, one can extract a fraction of the carbonate through precipitation. Solubility of sodium carbonate changes by more than a factor of three between 0° C. and 25° C. Thus it is possible to refresh the sodium hydroxide solution through a temperature swing, with heat exchange between the incoming fluid and outgoing fluid. This approach works best in warm climates where the maximum temperature swing is large. The refreshed hydroxide solution is sent back to the air contactor unit. This approach is also more likely to be deployed in dry climates where high NaOH concentrations reduce the concurrent water losses.

### Step 1.2

The sodium carbonate precipitate is dissolved in water at maximum concentration. The sodium carbonate is processed further in an electrochemical unit for acid/base separation that can separate sodium carbonate into sodium hydroxide (the base) and sodium bicarbonate (the acid). There are several different designs possible for this electrochemical separation. Some are conventional and state of the art generic separators for acid and base that use bipolar membranes. Others may involve hydrogen electrodes. Below we describe a particular unit specifically designed for sodium carbonate disassociation.

### Step 1.3

The bicarbonate solution resulting from Step 1.2 is injected into a pressure vessel where it mixes with a weak acid. Possible acids include citric and acetic acid. However, in this discussion we are not limited to any specific acid. The acid base reaction drives carbonic acid out of the system which decomposes into CO₂ and water. CO₂ at first dissolves into the brine but soon reaches a pressure that exceeds the container pressure, leading to the release of a pressurized CO₂ stream. The design constraints on this unit put some limits on the choice of an acid. Most importantly, the acid needs to be strong enough to drive CO₂ out of the solution, even at the design pressure. For a further discussion of this unit see below. The advantage of such a system is that it allows the release of concentrated CO₂ at pipeline pressure without having to put a large electrochemical unit into a pressure vessel. Left behind is a brine of the salt of the weak acid. This could be sodium acetate, sodium citrate or any other salt of a weak acid.

### Step 1.4

The salt of the weak acid and the base used in the capture is decomposed in an electro-dialysis unit utilizing cationic, anionic and bipolar membranes to recover sodium hydroxide and the weak acid. There are several variations of this unit that all could be considered. We can rely here on the state of the art, but we note that further advances in the design of this unit do not change the overall flowsheet of the process. With the conclusion of Step 1.4 the CO₂ has been recovered, and the last sodium hydroxide has been returned to the overall cycle. It is advantageous to use a unit that removes sodium ions from the acid rather than removing the anion from the mixture, as it would be undesirable to send residual acid into the air contactor. This also makes it possible to control the concentration of the sodium hydroxide brine. Depending on the detailed conditions of the implementation, this last unit can therefore be used to adjust the water content of the sodium hydroxide to match what is desired in the air contactor.

### Process 2:

This process is very similar to Process 1, but it replaces the first step with a membrane separation system. This will create a relatively dilute NaOH solution that in turn needs to be concentrated. It could be used in subsequent steps as the starting brine on the hydroxide side of the membrane.

### Step 2.1

Use a periodic system of cells with dilute NaOH followed by concentrated NaOH/Na₂CO₃ brine. On the one side the cells are separated by a cationic membrane on the other by a bipolar membrane. The last cell is connected to the first cell making the system periodic. It could be reduced to a simple pair of cells, but geometrical constraints may favor a multiple cell system. As the sodium diffuses through the cationic membrane, charge neutrality of the cells demands that the bipolar membrane provide an H⁺ —OH⁻ pair. The H⁺ neutralizes the left behind OH⁻ the OH⁻ forms a base with the withdrawn sodium in the other chamber. To a first approximation, the sodium concentration in the two chambers will balance out, suggesting that this separation can be performed without electric power input if at least half of the NaOH in the spent solvent has been converted into sodium carbonate. If this is not the case, it is still possible to use this system to partially reduce the NaOH concentration, or if one is willing to increase the water content of the solution, one can transfer a larger fraction of the sodium ions into the new hydroxide chamber. Adding water at this stage may often be desirable, as many air contactor designs will have lost some of the water that was originally in the solution. However, process step 2.2 which is the direct analog of process step 1.2 can also proceed if the extraction of NaOH was not entirely complete.

Note, by taking a number of these cell arrangements (without the closure at the end) and incorporating them into a stack that is used in step 2.2 to generate sodium bicarbonate, one can harness the power of the concentration driven cells to partially provide the driving term for the second step in the conversion.

### Step 2.2

This process is very similar as Step 1.2 above. The difference is that the sodium carbonate is delivered in dissolved form, and it is possible that there is residual sodium hydroxide left in the input brine,

### Step 2.3 and Step 2.4

Steps 2.3 and 2.4 are the same as Steps 1.3 and 1.4.

### Process 3:

For the sake of process simplicity we eliminate the step of electrochemically separating sodium carbonate into sodium hydroxide and sodium bicarbonate. Instead we use the weak acid immediately to produce CO₂. This implementation is included for its simplicity, and because it allows to take advantage of the future state of the art, that may have reached extremely efficient implementations for acid/base separation in some specific acid/base pair. It is of course possible to also generate a hybrid process where steps 1.1 and 2.1 may be pushed further than just to the carbonate boundary. As another alternative one could use the electrochemical separation in 1.2 and 2.2 but stop short of the full formation of sodium bicarbonate.

### Step 3.1

This step separates sodium carbonate from the sodium hydroxide in the input brine. This step could either be accomplished as in Step 1.1 or as in Step 2.1. It could also completely be eliminated introducing a hydroxide carbonate mixture into step 3.2.

### Step 3.2

Step 3.2 is the analog to Steps 1.3 and 2.3 but it requires twice as much acid. The advantage of such an implementation is a substantial streamlining of the flow sheet.

### Step 3.3

Step 3.3 is the analog to Steps 1.4 and 2.4, but it produces twice as much acid.

### Process 4:

Process 4 starts out like processes 1 and 2, but then replaces the acid decomposition with a bipolar membrane process that drives the CO₂ out of solution.

### Step 4.1

Step 4.1 is the same as Step 1.1 or 2.1

### Step 4.2

Step 4.2 is the same as Step 1.2 or 2.2

### Step 4.3

Electrochemical separation of NaHCO₃ into CO₂ and. NaOH. This is based on electrodialysis with bipolar membranes. In order to obtain high pressure CO₂ the electrodialysis unit should be put into a pressure tank which maintains the desired CO₂ pressure over the cell. For this reason it would be desirable not to combine steps 4.2 and 4.3 as this would increase the size of the unit that needs to be maintained at pressure. It is however possible to combine the two units into one. It would even be possible to combine all three units into one. Other implementation would use other electrochemical means, as for example an electrolysis system that on the cathode generates hydrogen on for the anode uses a hydrogen electrode that consumes the hydrogen produced at the cathode.

### Process 5:

Processes 5 and 6 extract CO₂ from the bicarbonate brine producing at least in part sodium carbonate and thus introduces a new recirculation loop between the final steps and the upstream steps. Process 5 precipitates out sodium bicarbonate whereas process 6 implements an aqueous version of the process.

### Step 5.1

Step 5.1 is the same as in Step 1.1 or 2.1.

### Step 5.2

Step 5.2 is the same as in Step 1.2 or 2.2. However, the input to this unit is in part derived from process 5.1 and in part from recycled sodium carbonate derived from Step 5.5.

### Step 5.3

Increase the concentration of bicarbonate through water removal. This is best accomplished by letting water pass through water permeable membranes into concentrated brines. There are two possible sources for these brines (a) the concentrated brines that leave the air contactor this is particularly useful if Step 5.1 follows 2.1, (2) the concentrated brines that are derived from Step 5.1 if it is analogous to 1.1 and results in solid sodium carbonate precipitate. The result is a concentrated brine of sodium bicarbonate. It needs to be contained in an air tight container so as to contain the higher than ambient CO₂ partial pressure over the solution.

Another option for dewatering the brine is to run a conventional electrodialysis unit (without bipolar membranes) in reverse. Rather than using the pure water which will be reused elsewhere in the cycle (the total system loses water) the concentrate brine on the other side of the membrane will be collected for further use. The advantage of this approach is that requires smaller volumes to pass through membranes but it requires an electromotive force to succeed.

### Step 5.4

Temperature swing to precipitate sodium bicarbonate from the brine. The temperature swing is not as efficient as the temperature swing for the precipitation of Na₂CO₃. However, operating between 25 and 0° C. would allow one to remove roughly ⅓ of the bicarbonate, Heat exchange between input and output minimizes heat losses in the system. The remaining brine is sent back to Step 5.3

### Step 5.5

Calcination of solid sodium bicarbonate to form sodium carbonate and pressurized CO₂. In order to pressurize the CO₂, the calciner is contained in a pressure vessel. Such a system could utilize various sources of waste heat, e.g. from a refinery or from a power plant. Another alternative might be solar energy which has the advantage of being carbon neutral. If fossil carbon is used the heat source should use oxygen rather than air and collect the CO₂ that results from its combustion. Hydrogen produced in the upstream electrodialysis units would provide another CO₂ free source of energy. Alternatively, a small fraction of the sodium carbonate produced could be used in part to adsorb the CO₂ from the combustion process. This sodium bicarbonate brine is returned to 5.3 in order to be dewatered again. The remaining sodium carbonate is sent back to Step 5.2 The CO₂ stream leaves from this unit.

The advantage of this implementation is that it reduces the electricity demand and replaces it in part with low grade heat. This method is therefore particularly useful in regions where electricity is expensive, or very CO₂ intensive. Methods 1-4 are advantageous in regions with low cost, low carbon electricity. E.g. Hydroelectricity.

### Process 6:

Process 6 is similar to Process 5, but it replaces the precipitation/calcination with a thermal decomposition of sodium bicarbonate directly in solution. The advantage of Process 5 is that it can easily achieve high pressure in the CO₂ stream, whereas Process 6 is easier to implement and it follows conventional processing streams.

### Step 6.1

Step 6.1 is the same as Step 5.1.

### Step 6.2

Step 6.2 is the same as Step 5.2.

### Step 6.3

Step 6.3 is the same as Step 5.3, but concentrations can be kept lower than in Step 5.3 and in some implementations it could be omitted.

### Step 6.4

Temperature swing to heat the solution to remove CO₂ from the brine and return a brine enriched in sodium carbonate back to Step 5.2. Heat exchangers are used to minimize energy demand. Water condensation can be managed inside the unit. See discussion below. Potential heat sources are similar to those listed in Step 5.5. A fraction of the brine produced in 6.2 can be used to absorb CO₂ produced in the heat generation. The resulting sodium carbonate rich brine is returned to Step 6.2.

### Process 7:

Process 7 is similar to Processes 5 and 6 in that it operates the CO₂ generating unit strictly between bicarbonate and carbonate and that it makes no attempt to drive the electrodialysis of the CO₂ generator past this point. It may indeed stop slightly before that so as to avoid creating high pH solutions.

### Step 7.1

Step 7.1 is the same as in Step 6.1.

### Step 7.2

Step 7.2 is the same as in Step 6.2.

### Step 7.3

Step 7.3 is the same as in Step 6.3.

### Step 7.4

A cell alternating anionic and bipolar membranes with a basic brine starting out as bicarbonate solution and the acidic brine as pure water, where the applied voltage drives the bicarbonate ions and carbonate ions across the anionic membrane to create carbonic acid which will release CO₂ on the basic side the brine gradually rises in pH, the process must stop when OH⁻ concentrations start to compete with dissolved inorganic carbon. This brine is sent back to the previous unit, after some dewatering to be reconverted into a bicarbonate brine.

### DISCUSSION OF THE PROCESSES

The processes outlined above represent different optimizations for different situations and different goals. Which one will prove optimal will depend on the typical temperatures at which the units operate, on the local cost and carbon intensity of electricity, on the progress of various electrochemical schemes to generate acid and base. As this field is still young and in flux, it is possible that over time the advantage will move more and more to the fully electrochemical designs.

Processes 1 through 4 which all rely on a second acid to complete the transformation of the spent solvent into CO₂ and fresh solvent make it possible to independently optimize acid/base separation and pressurization of CO₂. The advantage of these methods is that they completely eliminate the need of compressors for driving CO₂ up to pipeline pressure. The same is true for Process 5, but for Process 6 the maximum pressure that can be achieved is limited by the temperature to which one is willing to drive the carbonatelbicarbonate brine. One advantage of Process 6 is that Step 6.4 has been implemented in the past on large scales and thus reduces cost uncertainties associated with the scale up of new processes. However, we emphasize that everyone of the unit processes discussed here have been implemented before.

Other process units may be integrated into the overall stream to deal for example with impurities. For example, the carbonate brine arriving from the air contactor will be filtered to remove dust accumulation.

While we discuss below in some detail more specialized implementations of unit processes that are optimized for our design. However, one can use standard implementations for all process units.

### Example 2

### Implementation of the Separation of Carbonate into Bicarbonate and Hydroxide

In principle any implementation of an established electrochemical process for separating acid and base can be adapted for this process unit. Not all of them rely on bipolar membranes but many of them do. One we have developed for this purpose combines a series of cationic and bipolar membranes. The system ends in two standard electrodes producing hydrogen and oxygen. These will be responsible for a few percent of the total energy consumption. They can either be integrated into the process via a fuel cell or—in Processes 5 and 6, which require heat—they can be combusted to produce heat without CO₂ emission.

Sodium ions follow either a concentration gradient or an electric gradient from the mixture into the next cell which is accumulating sodium hydroxides. Different sections of the cell may be working on different concentrations in order to minimize potential differences in the system. In particular, as mentioned before it is possible to include the upstream separation of hydroxide from carbonate which can be driven by concentration gradients alone. Since none of the units reach acidic pH, the proton concentration is everywhere small enough to avoid the need for compartments separated by anionic membranes. The system is therefore simpler than a conventional bipolar membrane system that needs to control proton currents. In these cells the negative ions do not leave the cell they started in. The advantage of extracting sodium carbonate from the solvent brine prior to this step is that it reduces the amount of sodium that has to pass through these membranes. However, a simplified version of the process can eliminate the first step.

### Example 3

### Implementation of the Acid Driven CO₂ Generator

Mixing an acid with sodium carbonate or bicarbonate leads to the vigorous production of CO₂. If the acid is strong enough, the entire process can generate high pressures of CO₂ if the reaction is contained in a vessel that is held at the desired pressure. One possible use for such a system would be to generate CO₂ at pressures that are above pipeline pressure, eliminating the need for subsequent compression.

One possible implementation of such a system envisions three small reservoirs, one filled with acid, one filled with bicarbonate and the third filled with the salt (e.g., sodium salt) of the acid. The bicarbonate and acid are injected from their respective reservoirs into a flow channel shaped to enhance mixing of the two fluids. The channel rises to a high point where the gas is separated from the liquid flow which then is channeled downward again to enter the salt solution reservoir. The injectors into the acid and base reservoir are mechanically coupled to the salt exhaust reservoir. The mechanical energy harnessed at the exit is nearly sufficient to drive the injection pumps. A direct mechanical coupling could be based on piston displacement pumps which are mechanically connected. Small turbines could similarly be coupled together.

Small systems may instead operate in a batch operation where the input tanks and output tanks are separated for example by a diaphragm. When the pressure is released filling the empty input tanks forces the draining of the full output tank. Then the system is pressure isolated from its environment and CO₂ is produced as the two fluids are pumped from the input tank into the output tank. Once the output tank is full, the CO₂ line is valved off, and the cycle repeats itself. Another implementation could use pistons, which in effect replace the moving diaphragm.

It is of course also possible to provide electric coupling, by converting the output energy of the salt stream and CO₂ stream into electric power. A small mismatch in volumes could be made up by withdrawing some pressure energy from the CO₂ output line. In principle, this could be a substantial source of mechanical energy satisfying a large number of pumping needs within the overall system. One can use this ability to adjust the mismatch in strength between the carbonic acid and the acid used to drive the system.

In this way the acid production becomes a convenient way of providing mechanical energy which is removed from the exhaust carbon dioxide.

Prior to injection of the carbon dioxide into the output stream, it needs to be cleaned and dried so that it meets whatever requirements are put on it.

### Example 4

### Water Management in a Thermal Swing CO₂ Generator

In heating a bicarbonate solution, the CO₂ will carry with it water vapor that needs to be condensed out. The CO₂ which will leave the solution at some pressure will leave the reservoir mixed with water vapor. In the next stage it is used to preheat the incoming solution and in the process it condenses out the water vapor. The water collects at the bottom of the unit and is kept out of the bicarbonate solution as increasing the brine concentration raises the CO₂ partial pressure over the solution.

The water can be used in providing input feed for creating fresh sodium bicarbonate in the electrochemical acid/base separations in Step 6.2.

While the foregoing invention has been described in some detail for purposes of clarity and understanding, these particular embodiments are to be considered as illustrative and not restrictive. It will be appreciated by one skilled in the art from a reading of this disclosure that various changes in form and detail can be made without departing from the true scope of the invention.

1-34. (canceled)

35. A method for removing CO₂ from the air comprising:
binding the CO₂ as a carbonate in a hydroxide/carbonate brine,
concentrating the hydroxide/carbonate brine to approach a carbonate saturation point, and
separating the concentrated hydroxide/carbonate brine by thermal swing precipitation of the carbonate from the brine, wherein the separated carbonate is electrochemically separated into sodium hydroxide solution and sodium carbonate solution by electrodialysis through bipolar membranes.

36. The method of claim 35, further comprising mixing the bicarbonate with an acid to release a more concentrated carbon dioxide, recovering the acid through electrodialysis, and recycling the acid to neutralize the brine.

37. A method for removing CO₂ from the air comprising:
binding the CO₂ as a carbonate in a hydroxide/carbonate brine in a device that comprises a plurality of cells separated by alternating bipolar membranes and cationic membranes,
flowing concentrated carbonate brine and a dilute NaOH solution, respectively, through alternating cells, whereby sodium ions transfer across the cationic membranes, and the bipolar membranes provide necessary hydroxide ions and protons to maintain charge neutrality in the concentrated carbonated brine and the dilute NaOH solution.

38. The method of claim 37, wherein the first and last cell are connected to one another and contain fluid of the same type.

39. The method of claim 38, wherein the cells are arranged in a toroidal shape.

40. The method of claim 37, wherein the number of the plurality of cells is two.

41. The method of claim 37, further comprising:
electrochemically separating the carbonate into a sodium hydroxide solution and a sodium bicarbonate solution by electrodialysis through said bipolar membranes.

42. The method of claim 41, further comprising:
mixing the bicarbonate with an acid to release carbon dioxide; and
recovering the acid from its salt by electrodialysis through said bipolar membranes.

43. The method of claim 35, wherein the acid is added in a first and a second step, wherein the first step takes place in a low pressure system that adjusts the mixture to a pH level that supports the formation of bicarbonate, and the second step takes place in a high pressure system that generates high pressure CO₂.

44. The method of claim 35, wherein hydrogen is generated at a cathode and consumed again at an anode.

45. A method for removing CO₂ from the air comprising:
binding the CO₂ as a carbonate in a hydroxide/carbonate brine,
concentrating the hydroxide/carbonate brine to approach a carbonate saturation point, and
separating the concentrated hydroxide/carbonate brine by mixing the bicarbonate with an acid to release carbon dioxide, recovering the acid through electrodialysis, and recycling the acid to neutralize the brine.

46. The method of claim 45, wherein the concentrated hydroxide/carbonate brine is further separated by thermal swing precipitation of the carbonate from the brine.

47. The method of claim 35, further comprising thermal decomposition of sodium bicarbonate to form sodium carbonate and CO₂, and recycling the sodium carbonate to the earlier stages of the process.

48. The method of claim 47, further comprising:
reducing the water content of the bicarbonate solution through membrane separation driven by concentration gradients or electrochemical gradients (reverse electrodialysis);
extracting bicarbonate from the concentrated brine in a thermal swing precipitation followed by a thermal calcination of the bicarbonate to CO₂ and carbonate; and
recycling the dilute bicarbonate output stream to another dewatering of the bicarbonate solution.

49. The method of claim 47, wherein the bicarbonate solution is heated until CO₂ is released resulting in a carbonate/bicarbonate brine which is electrochemically reprocessed to bicarbonate.

50. The method of claim 49, wherein the bicarbonate solution evolves CO₂ inside a pressure vessel.

51. The method of claim 47, wherein a heat exchange between inputs and outputs of the thermal decomposition step and the thermal calcinations step minimizes energy consumption.

52. The method of claim 47, wherein any dilute water streams generated are kept out of the brines and treated as off-water.

53. The method of claim 52, wherein the dilute water streams are used as make-up water.

54. The method of claim 35, wherein the hydroxide carbonate brine contains a base ion and wherein the base ion of the hydroxide carbonate brine is sodium.

55. The method of claim 35, wherein the hydroxide carbonate brine contains a base ion and wherein the base ion of the hydroxide carbonate brine is potassium.

56. The method of claim 35, wherein the hydroxide carbonate brine contains a base ion and wherein the base ion of the hydroxide carbonate brine is a mixture including sodium and potassium.

57. The method of claim 35, wherein the hydroxide carbonate brine contains a base ion and wherein the base ion is an organic base.

58. The method of claim 41, further comprising thermal decomposition of sodium bicarbonate to form sodium carbonate and CO₂, and recycling the sodium carbonate to the earlier stages of the process.

59. The method of claim 37, wherein the hydroxide carbonate brine contains a base ion and wherein the base ion of the hydroxide carbonate brine is sodium.

60. The method of claim 37, wherein the hydroxide carbonate brine contains a base ion and wherein the base ion of the hydroxide carbonate brine is potassium.

61. The method of claim 37, wherein the hydroxide carbonate brine contains a base ion and wherein the base ion of the hydroxide carbonate brine is a mixture including sodium and potassium.

62. The method of claim 37, wherein the hydroxide carbonate brine contains a base ion and wherein the base ion is an organic base.
